(19) United States
(12) Patent Application Publication
(10) Pub. No.: US 2007/0256799 A1
(43) Pub. Date: Nov. 8, 2007

(54) Sun screen device

(75) Inventor: Paul Lin, Tainan Hsien (TW)

Correspondence Address: FROMMER LAWRENCE & HAUG, 745 FIFTH AVENUE- 10TH FL., NEW YORK, NY, 10151, US

(73) Assignee: Macauto Industrial Co., Ltd.

(21) Appl. No.: 11/416,141

(22) Filed: May 2, 2006

(51) Int. Cl. E06B 9/56

(52) U.S. Cl. 160/273.1

(57) ABSTRACT

A sun screen device includes a pair of slide rails, a shaft unit, a screen body, and a guiding unit. The shaft unit includes a pair of seat members and a shaft member. The shaft member has opposite shaft end portions that are mounted rotatably and respectively to the seat members, and a middle portion that extends between the shaft end portions. The guiding unit includes first and second protruding structures, each of which is provided on a respective one of lateral ends of the screen body and is coupled movably to a respective one of the slide rails. Each of the shaft end portions is reduced in cross-section from the middle portion of the shaft member so as to define a recess with the middle portion for receiving a respective one of the first and second protruding structures.

### BACKGROUND OF THE INVENTION

1. Field of the Invention

This invention relates to a sun screen device that is operable so as to cover and uncover an automobile window.

2. Description of the Related Art

FIG. 1 illustrates a conventional sun screen device 1 that includes a pair of elongate slide rails 12, a shaft unit 11, a screen unit 13, and a guide unit 14. Each of the slide rails 12 has first and second ends 121, 122 that are opposite to each other, and defines a rail groove 120 therein. The shaft unit 11 includes a pair of seat members 111, a shaft member 112, and a shaft cover 113. The seat members 111 are respectively disposed proximate to the first ends 121 of the slide rails 12. The shaft member 112 has opposite shaft end portions, each of which is coupled rotatably to a respective one of the seat members 111. The shaft cover 113 serves to conceal the shaft member 112. The screen unit 13 includes a flexible screen body 131 for covering an automobile window (not shown). The screen body 131 has opposite lateral ends 1311, a securing end 1312 that interconnects the lateral ends 1311 and that is secured to the shaft member 112 of the shaft unit 11, and a terminating end 1313 that is opposite to the securing end 1312 and that interconnects the lateral ends 1311. The terminating end 1313 of the screen body 131 is movable away from the shaft unit 11 such that the screen body 131 is unwound from the shaft member 112 of the shaft unit 11 to thereby cover the automobile window, and toward the shaft unit 11 such that the screen body 131 is wound on the shaft member 112 of the shaft unit 11 to thereby uncover the automobile window. The guide unit 14 serves to guide movement of the screen body 131. In particular, the guide unit 14 includes a first set of spaced apart ball-shaped sliding members 141 that are provided along one of the lateral ends 1311 of the screen body 131 and that are disposed slidably in the rail groove 120 of one of the slide rails 12, and a second set of spaced-apart ball-shaped sliding members 142 that are provided along the other one of the lateral ends 1311 of the screen body 131, and that are disposed slidably in the rail groove 120 of the other one of the slide rails 12.

Although the conventional sun screen device 1 can achieve its intended purpose, when the terminating end 1313 of the screen body 131 is moved toward the shaft unit 11, as illustrated in FIG. 2, the ball-shaped sliding members 141 in the first set, as well as those in the second set, overlap each other. This results in bulging at both shaft end portions of the shaft member 112. As such, a relatively large shaft cover 113 is required in order to conceal the shaft member 112.

### SUMMARY OF THE INVENTION

Therefore, the object of the present invention is to provide a sun screen device that can overcome the aforesaid drawback of the prior art.

According to the present invention, a sun screen device comprises a pair of elongate slide rails, a shaft unit, a flexible screen body, and a guiding unit. Each of the slide rails has opposite first and second rail ends, and defines a rail groove therein. The shaft unit includes a pair of seat members and a shaft member. Each of the seat members is disposed proximate to the first rail end of a respective one of the slide rails. The shaft member has opposite shaft end portions, each of which is mounted rotatably on a respective one of the seat members, and a middle portion that extends between the shaft end portions. The screen body has opposite lateral ends, a securing end that interconnects the lateral ends and that is secured to the shaft member, and a terminating end that is opposite to the securing end and that interconnects the lateral ends. The terminating end of the screen body is movable toward the shaft unit such that the screen body is wound on the shaft member. The guiding unit serves to guide movement of the screen body, and includes first and second protruding structures, each of which is provided on a respective one of the lateral ends of the screen body and is disposed slidably in the rail groove in a respective one of the slide rails. Each of the shaft end portions of the shaft member is reduced in cross-section from the middle portion of the shaft member so as to define a recess with the middle portion for receiving a respective one of the first and second protruding structures when the terminating end of the screen body is moved toward the shaft unit.

### BRIEF DESCRIPTION OF THE DRAWINGS

Other features and advantages of the present invention will become apparent in the following detailed description of the preferred embodiments with reference to the accompanying drawings, of which:

FIG. 1 is a partly exploded perspective view of a conventional sun screen device;

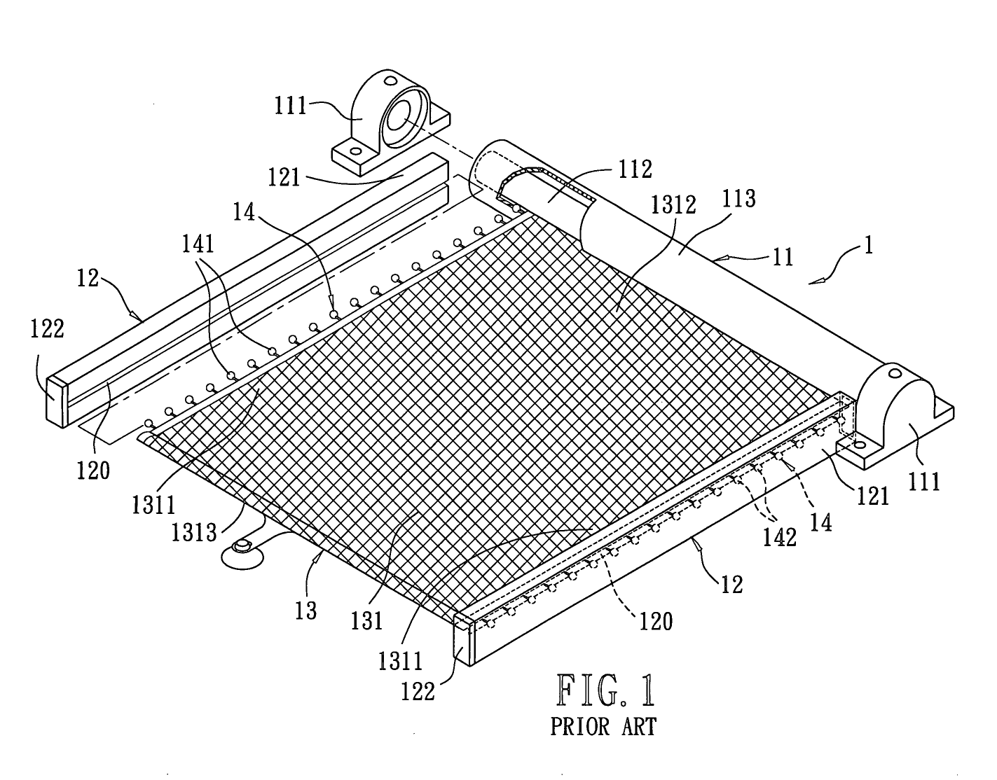

FIG. 2 is a fragmentary, schematic partly sectional view to illustrate a state where a screen body is wound on a shaft member of the conventional sun screen device;

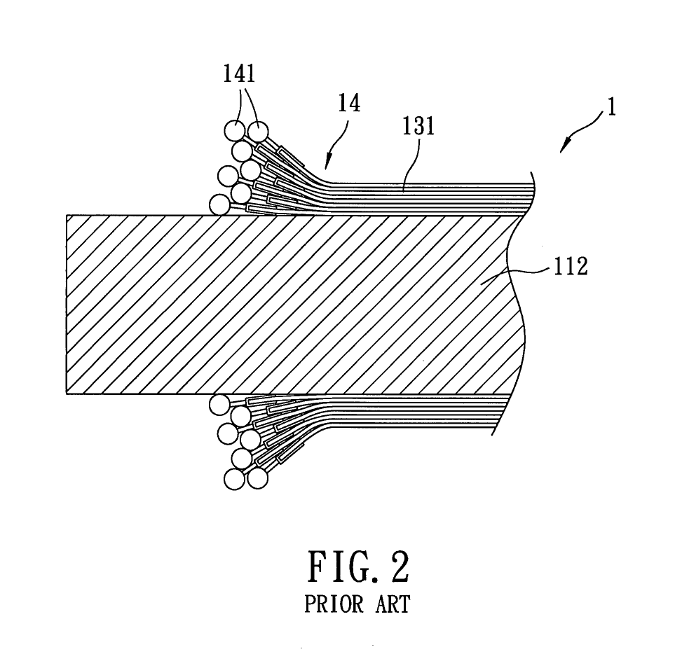

FIG. 3 is a partly exploded perspective view of the first preferred embodiment of a sun screen device according to the present invention;

FIG. 4 is a fragmentary, schematic partly sectional view to illustrate a state where a screen body is unwound from a shaft member of the first preferred embodiment;

FIG. 5 is a fragmentary, schematic partly sectional view to illustrate a state where the screen body is wound on the shaft member of the first preferred embodiment; and

FIG. 6 is a fragmentary, schematic partly sectional view of the second preferred embodiment of a sun screen device according to this invention.

### DETAILED DESCRIPTION OF THE PREFERRED EMBODIMENTS

Before the present invention is described in greater detail, it should be noted that like elements are denoted by the same reference numerals throughout the disclosure.

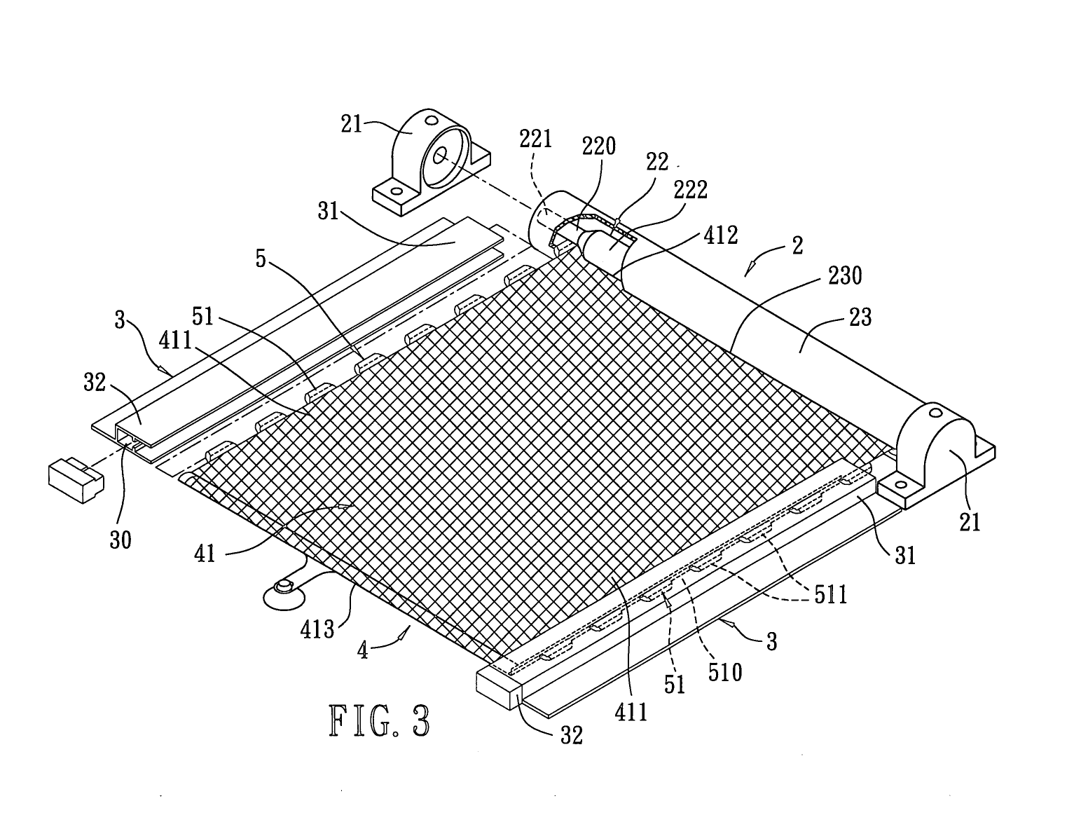

Referring to FIG. 3, the first preferred embodiment of a sun screen device according to this invention is shown to include a pair of elongate slide rails 3, a shaft unit 2, a screen unit 4, and a guiding unit 5.

In this embodiment, the sun screen device is mounted adjacent to an automobile window (not shown). In an alternative embodiment, the sun screen device may be mounted beneath a sunroof (not shown) of an automobile (not shown).

Each of the slide rails 3 has first and second rail ends 31, 32 that are opposite to each other, and defines a rail groove 30 therein.

The shaft unit 2 includes a pair of seat members 21 and a shaft member 22. The seat members 21 are respectively disposed proximate to the first rail ends 31 of the slide rails 3. The shaft member 22 has opposite shaft end portions 221 (only one is shown in FIG. 3) that are mounted rotatably and respectively on the seat members 21, and a middle portion 222 that extends between the shaft end portions 221. In this embodiment, each of the shaft end portions 221 of the shaft member 22 is reduced in cross-section from the middle portion 222 of the shaft member 22 so as to define a recess 220 with the middle portion 222.

The shaft unit 2 further includes a shaft cover 23 for concealing the shaft member 22. In this embodiment, the shaft cover 23 is sleeved on the shaft member 22, is mounted on the seat members 21, and is formed with an opening 230 that extends there along. In an alternative embodiment, the shaft cover 23 of the shaft unit 2 may be dispensed with.

The screen unit 4 includes a flexible screen body 41 that extends through the opening 230 in the shaft cover 23 and that is operable so as to cover the automobile window. In particular, the screen body 41 has opposite lateral ends 411, a securing end 412 that interconnects the lateral ends 411 and that is secured to the shaft member 22, and a terminating end 413 that is opposite to the securing end 412 and that interconnects the lateral ends 411. In this embodiment, the terminating end 413 of the screen body 41 is movable away from the shaft unit 2 such that the screen body 41 is unwound from the shaft member 22 to thereby cover the automobile window, and toward the shaft unit 2 such that the screen body 41 is wound on the shaft member 22 to thereby uncover the automobile window.

The screen unit 4 further includes a biasing member (not shown) for biasing the terminating end 413 of the screen body 41 toward the shaft unit 2. Since the construction of the biasing member is known to those skilled in the art, a detailed description of the same will be dispensed with herein for the sake of brevity.

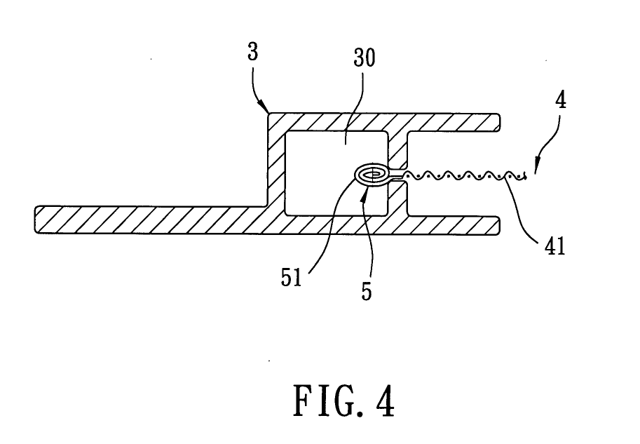

The guiding unit 5 serves to guide movement of the screen body 41, and includes first and second protruding structures 51. In this embodiment, each of the first and second protruding structures 51 includes a plurality of spaced apart hems 511 that are provided along a respective one of the lateral ends 411 of the screen body 41, and that are disposed slidably in the rail groove 30 in a respective one of the slide rails 3, as best shown in FIG. 4.

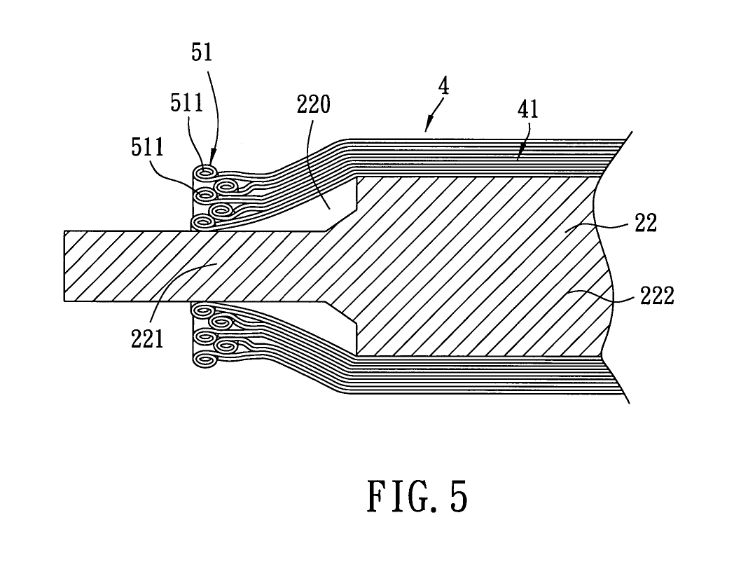

It is noted that when the terminating end 413 of the screen body 41 is moved toward the shaft unit 2, as best shown in FIG. 5, the hems 511 of the first protruding structure 51 of the guiding unit 5 are received in the recess 220 between one of the shaft end portions 221 and the middle portion 222 of the shaft member 22, whereas the hems 511 of the second protruding structure of the guide unit 5 are received in the recess between the other one of the shaft end portions and the middle portion 222 of the shaft member 22, thereby minimizing bulging at both shaft end portions 221 of the shaft member 22. Moreover, each of the hems 511 has a length equal to the spacing 510 between adjacent ones of the hems 511. As such, the hems 511 fit in the spacings when the terminating end 413 of the screen body 41 is moved toward the shaft unit 2, thereby further minimizing bulging at both shaft end portions 221 of the shaft member 22.

It is noted that the hems 511 of the first protruding structure 51 are formed on one of the lateral ends 411 of the screen body 41 by rolling the lateral end 411 of the screen body 41 first, and then by forming cutouts, which serve as the spacings 510, in the rolled lateral ends 411 of the screen body 41 so as to configure the rolled lateral end 411 of the screen body 41 with the hems 511. The hems 511 of the second protruding structure 51 are formed on the other one of the lateral ends 411 of the screen body 41 in a similar manner.

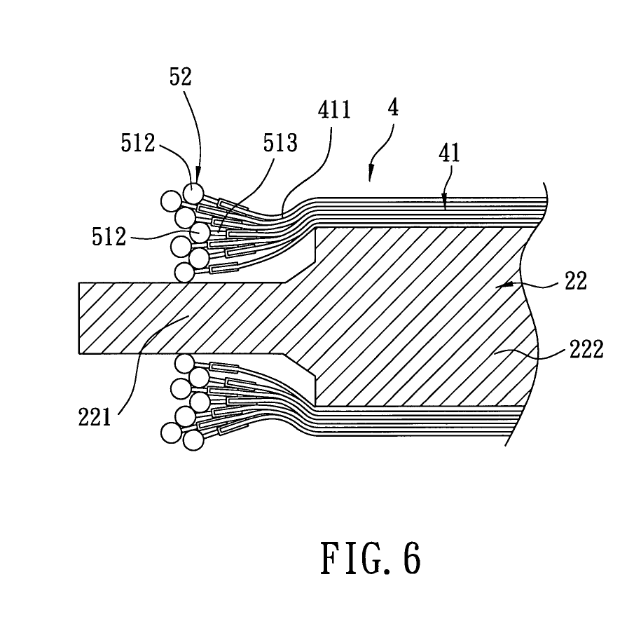

FIG. 6 illustrates the second preferred embodiment of a sun screen device according to this invention. When compared with the previous embodiment, each of the first and second protruding structures 51 (only the first protruding structure 51 is shown in FIG. 6) of the guiding unit 5 includes a plurality of spaced apart ball-shaped sliding members 512, and a plurality of connectors 513. The connectors 513 of the first protruding structure 51 respectively connect the sliding members 512 of the first protruding structure 51 to one of the lateral ends 411 of the screen body 41. Similarly, the connectors of the second protruding structure respectively connect the sliding members of the second protruding structure to the other one of the lateral ends 411 of the screen body 41.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A sun screen device, comprising:
a pair of elongate slide rails, each of which has opposite first and second rail ends, and each of which defines a rail groove therein;
a shaft unit including
a pair of seat members, each of which is disposed proximate to said first rail end of a respective one of said slide rails, and
a shaft member having opposite shaft end portions, each of which is mounted rotatably on a respective one of said seat members, and a middle portion that extends between said shaft end portions;
a flexible screen body having opposite lateral ends, a securing end that interconnects said lateral ends and that is secured to said shaft member, and a terminating end that is opposite to said securing end and that interconnects said lateral ends, said terminating end of said screen body being movable toward said shaft unit such that said screen body is wound on said shaft member; and
a guiding unit for guiding movement of said screen body, and including first and second protruding structures, each of which is provided on a respective one of said lateral ends of said screen body and is disposed slidably in said rail groove in a respective one of said slide rails;
wherein each of said shaft end portions of said shaft member is reduced in cross-section from said middle portion of said shaft member so as to define a recess with the middle portion for receiving a respective one of said first and second protruding structures when said terminating end of said screen body is moved toward said shaft unit.

2. The sun screen device as claimed in claim 1, wherein each of said first and second protruding structures includes a plurality of spaced apart hems.

3. The sun screen device as claimed in claim 2, wherein each of said hems has a length equal to the spacing between adjacent ones of said hems.

4. The sun screen device as claimed in claim 1, wherein each of said first and second protruding structures includes a plurality of sliding ball-shaped members.

5. The sun screen device as claimed in claim 1, wherein said shaft unit further includes a shaft cover for concealing said shaft member.
